(19) United States
(12) Patent Application Publication
(10) Pub. No.: US 2008/0057457 A1
(43) Pub. Date: Mar. 6, 2008

(54) CLASP FOR REMOVABLE DENTAL APPLIANCES

(76) Inventor: Donal P. Inman, Coral Springs, FL (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/845,920

(22) Filed: Aug. 28, 2007

Related U.S. Application Data
(60) Provisional application No. 60/840,930, filed on Aug. 30, 2006.

(51) Int. Cl. A61C 7/08

(52) U.S. Cl. 433/6

(57) ABSTRACT

A clasp for a removable dental appliance includes a stem embedded into and extending from the acrylic portion of the appliance. Two ball clasps extend from the stem and are laterally spaced apart from one another. Each ball clasp has an elongated flexible member and an enlarged exposed end. A bridge segment extends laterally between the flexible members of the first and second ball clasps. The stem and ball clasps can be formed by two substantially parallel wires, with the bridge segment extending generally perpendicularly between the wires near their exposed ends adjacent to the ball clasps.

### RELATED APPLICATION

The present application is based on and claims priority to the Applicant's U.S. Provisional Patent Application 60/840,930, entitled “Double Ball Clasp (DBC),” filed on Aug. 30, 2006.

### BACKGROUND OF THE INVENTION

1. Field of the Invention

The present invention relates generally to the field of dentistry. More specifically, the present invention discloses a clasp for removable dental appliances.

2. Statement of the Problem

To serve a wide range of treatment functions, dental appliances are fabricated in a wide range of configurations. Actually, the term “appliance” in general dentistry can pertain to crown and bridge-type prosthetic devices. In orthodontics, the term “appliance” may relate to a transverse palatal expansion device or a post-treatment retainer. An orthodontic bracket attached to an individual tooth is sometimes referred to as an appliance. The present invention is directed to the category of appliances that are removable, like the post-treatment retainer-type orthodontic appliance referenced above. Such appliances are removable in that they can be selectively removed by the patient for eating or for social occasions and the like, and then later re-positioned in the mouth. Specifically, the present inventive device provides an improved means for retention of removable appliances.

A typical removable appliance is an upper retainer for an orthodontic patient after the active phase of treatment has been completed. Removable dental appliances are most commonly based on an acrylic mass adapted to the patient's teeth, palate and lingual anatomy. Such appliances are formed in the dental laboratory through a process starting with an impression of the patient's teeth and soft tissues. From the impression, a stone duplicate is obtained. The stone duplicate serves as a template in which the appliance is cast.

A typical fabrication sequence begins with the upper stone model for example. A release agent is applied to the teeth and soft tissue portions of the stone model. Next, poly-methyl-methacrylate powder and methyl-methacrylate monomer liquid are alternatingly applied directly within the stone model. The process of adding the powder and then the liquid is informally known as the “salt and pepper” method. The powder is wetted by the liquid monomer and the two components rapidly polymerize to form the well-known dental acrylic polymer that is often pink in color. Consecutive applications of these materials allow the acrylic portion of the appliance to build up to a sufficient thickness, providing adequate structural qualities. The technician can continue, selectively thickening targeted sections of an appliance that may require additional thickness.

During the step of alternatingly applying the poly-methyl-methacrylate powder and methyl-methacrylate monomer liquid, the lab technician will typically stop and lay in various types of pre-adapted active and passive metallic components into the nascent acrylic mass to provide any of a number of desired functionalities. Once the pre-adapted metallic components are positioned, the salt-and-pepper build-up process resumes, and thereby portions of the stainless steel components become embedded in the acrylic mass as it polymerizes. Removable acrylic retainer-type appliances are typically adapted either for the patient's lower arch or as a palate-conforming upper appliance. Both types of appliances often incorporate what are known as Hawley-type labial bows, which are contoured stainless steel wire portions adapted to span the labial side of the anterior teeth. In addition, conventional stainless steel ball clasps can project buccally from the acrylic mass to help retain the appliance in place. Portions of the metallic hardware of a Hawley bow and ball clasps can be rigidly captured in the acrylic mass and other portions emerge from the acrylic for various intended treatment functions.

In the same manner, many other types of metallic devices can also be embedded into removable dental and orthodontic appliances. Broadly speaking, all such embedded devices can be classified according to the following categories: (a) Active, energy storing components that serve to impart tooth-moving corrective forces to individual teeth or groups of teeth; (b) Active, force generating components that serve to impart corrective orthopedic forces directed to the maxilla and mandible and all of the bony support structures below the floor of the cranium; and (c) Passive, retentive devices that serve to hold teeth in ideal positions or that serve to positively and securely retain the appliance itself in a fully seated and stable position in the mouth. The Hawley bow and ball clasps described above are representative of this last group of devices in that both are passive structures. The Hawley bow serves only to hold teeth in desired positions and ball clasps serve to hold the entire appliance properly positioned in the mouth.

The present invention relates most closely to the ball clasp devices used to hold removable appliances fully seated and in position on a patient's teeth. Known clasps fall into several configurations. One example of a retentive clasp is taught by U.S. Pat. No. 5,096,416 to Hulsink. These are commercially known as Adams clasps. Adams clasps are available in widths that match the standard mesial-distal widths of various teeth. For example, a 7.0 mm Adams clasp may be positioned during fabrication of a removable appliance to bilaterally engage bicuspids. A 10 mm Adams clasp may be similarly placed to engage upper first molars and 11 or 12 mm Adams clasps may engage lower first molars. An example of a removable appliance incorporating Adams-type clasps is disclosed in U.S. Pat. No. 4,026,023 (Fisher).

Other types of conventional clasps are well known within orthodontics and dentistry. This group of products is widely available from many manufacturers and commercial distribution sources. For example, a wide variety of ball retainer clasps, arrow clasps, triangular clasps, and arrow anchors are marketed by Dentaurum of Pforzheim, Germany. The ball-type retainer clasps are perhaps most common. They are usually formed from moderately work-hardened stainless steel then cold forged using the cold-heading process. The stem portion ranges in diameter from about 0.024 to 0.032 inches. The ball portion is typically slightly less than twice the stem diameter.

Other non-ball clasp configurations are available commercially from multiple sources including Dentaurum. One of Dentaurum's offerings is based on a stem portion that is triangular rather than round in cross section. The triangular shape allows the stem portion to seat lower in the interproximal space between the teeth as it passes from the lingual to the buccal side, or from the lingual to the labial side of the teeth.

Regarding the examples of Dentaurum's commercial offerings mentioned above, each type of clasp (including the Adams clasp) exhibits a long stem portion. In all cases, the long stem portion is incorporated in order to provide a sufficient length of material for the lab technician's use in adapting the clasp to the patient's model. Typically, the majority of the stem is trimmed away and only the remaining portion is adapted to the contours of the palate and lingual tissues before being captured and retained within the acrylic mass. With a conventional ball clasp, the ball contacts the enamel of two adjacent teeth with the ball portion aggressively spring-biased into that position. Most of the stem portion of the clasp outside of the acrylic remains substantially straight or may be slightly curved to accommodate the occlusal-gingival contour of the two teeth engaged. However, the portion of stem adjacent to the ball is deformed and energetically biases the ball into the embrasure between the engaged teeth. The bending of the stem portion is accomplished so that the appliance stays in place, yet can be removed by the patient without undue difficulty or discomfort. So, the portion of the stem adjacent to the ball must flex to a degree when inserting the appliance into the mouth, allowing the ball to pass over the bell-shape of human teeth. It is the ball popping over of the tooth's largest circumferential dimension and the inward biasing of the ball into the undercut below the largest circumferential dimension that retains removable appliances in a seated position. It is the negative draft or undercut leading away gingivally from the maximum circumference of the crown that the clasps of removable appliances engage. In other words, in order for the appliance to lift away from its fully-seated position, the ball portion of the clasp must overcome the inward biasing and flex outward over the bell shape of the engaged teeth. This normally requires an intentionally-directed combination of forces delivered by the patient or the attending doctor and staff to remove the appliance.

Several shortcomings are present in conventional clasps of the type that are typically incorporated into removable acrylic-based appliances. One of those shortcomings involves the fact that the acrylic mass portion of such appliances is typically cast directly in the patient's model, therefore the acrylic portion tends to very accurately comply with all of the subtle nuances of the morphology of the palate and the lingual-gingival anatomy of the teeth. Given that, and the fact that saliva tends to wet-out the interface between the compliant acrylic portion and the soft tissues, a significant hydraulically-induced resistance to removal can exist. In other words, these factors can combine to make it difficult for a patient to remove such an appliance because removal forces must overcome a slight vacuum effect of the accurate wetted fit of the appliance onto the soft tissues.

Another problem is associated most directly with the Adams configuration. The Adams-type clasp exhibits features that serve multiple functions including that of a handle, allowing the patient's fingernail for example to gain purchase for removal of the appliance. However, the handle of an Adams clasp is relatively straight and orthogonally oriented to the configuration of the clasp. As such, two corners are formed that abut the soft tissues of the cheek. Over time, and under not uncommon conditions, irritation and ulceration of the cheek tissues can result from the continuous pressure of these protrusive features.

Finally, conventional ball clasps can undesirably reposition teeth to which they contact. It should be recalled that conventional ball clasps function by energetically engaging the embrasure between two teeth. As described above, conventional ball clasps serve to retain the appliance in which they are embedded by positively flexing into the embrasure and in a sense, the ball portion jams into the interface between two teeth. As such, the inward force of the ball portion can, over time, cause the two contacted teeth to reposition in response to the inward jamming and wedging effect of the ball. In other words, the stored energy in the stem portion that inwardly biases the ball can itself cause an unwanted orthodontic problem.

To counter the tendency of teeth to spread apart in response to the wedging effect of the ball, the lingual contour of the acrylic portion of conventionally clasped removable appliances can be built-up with additional thickness in areas adjacent to the ball clasp on the lingual side of the teeth. The acrylic build-up is intimately compliant with the lingual anatomy of the teeth and serves to stabilize them against the tendency to rotate in response to the wedging effect of the ball clasp. Such steps are mostly effective, but require additional time and skill to fabricate.

Solution to the Problem. The present invention addresses a number of the shortcomings associated with the prior art. For example, the present invention includes a bridge segment that serves as a handle, making the step of removing the appliance easier. In addition, the bridge segment can be biologically contoured to follow the surface of a tooth. This is in contrast to the Adams clasp, in which the handle is relatively straight and protrusive.

Another novel aspect of the present invention is that various configurations of the bridge segment can be readily provided by the manufacturer to maintain a close contour to the buccal morphology on a tooth-by-tooth basis.

Yet another advance in clasp design, forwarded by the present invention, involves the force vectors with which the ball clasps grasp an individual tooth without causing unwanted reciprocal tooth movement. This greatly reduces or eliminates the need for reciprocal tooth stabilizing features to be incorporated into the acrylic portion of the appliance, as previously discussed. The present inventive clasp can be designed to place no wedging forces in the interproximal embrasure between teeth.

### SUMMARY OF THE INVENTION

This invention provides a clasp for a removable dental appliance that includes a stem embedded into and extending from the acrylic portion of the appliance. Two ball clasps extend from the stem and are laterally spaced apart from one another. Each ball clasp has an elongated flexible member and an enlarged exposed end. A bridge segment extends laterally between the flexible members of the first and second ball clasps. The stem and ball clasps can be formed by two substantially parallel wires, with the bridge segment extending generally perpendicularly between the wires near their exposed ends adjacent to the ball clasps.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of a clasp 25.

FIG. 2 is a perspective view of a dental appliance incorporating a number of clasps 25.

FIG. 3 is a perspective view of the dental appliance in place on a patient's lower teeth.

FIG. 4 is a perspective view of a clasp 25 after forming.

FIG. 5 is a top view of a bridge segment 50 of a clasp.

FIG. 6 is a rear view of a bridge segment 50.

FIG. 7 is a side view of a bridge segment 50.

FIG. 8 is a perspective view of a bridge segment 50.

FIG. 9 is a perspective view showing the manner in which the ball clasps 35, 45 flex as the clasp 25 is moved into place over a tooth 10.

### DETAILED DESCRIPTION OF THE INVENTION

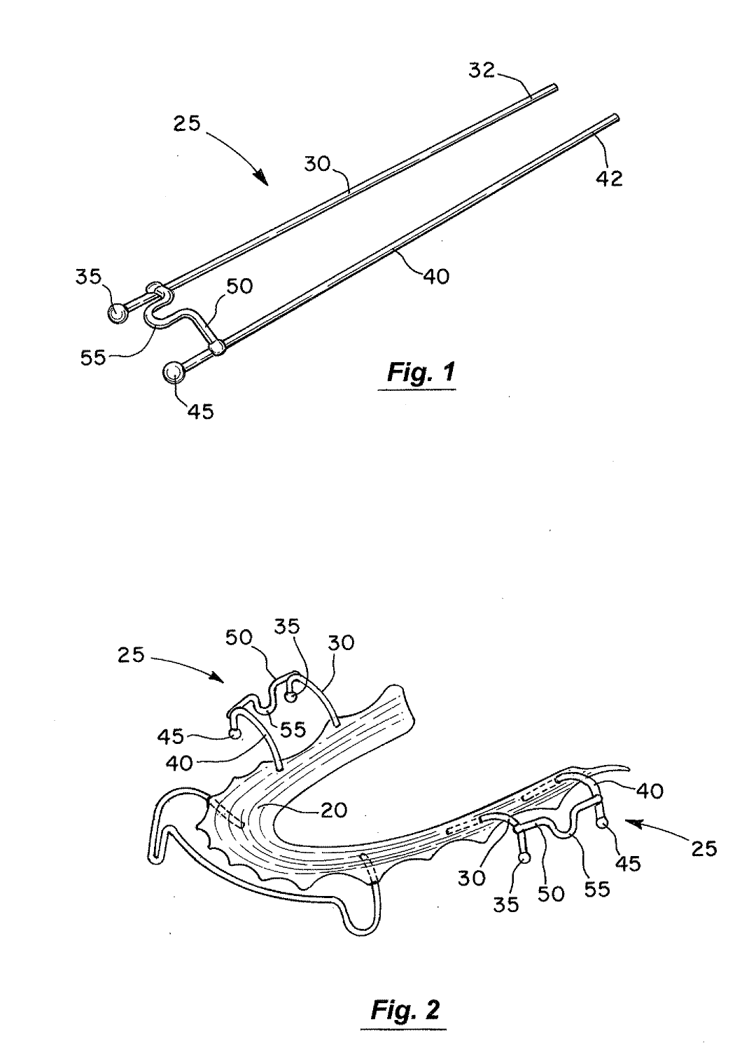

Turning to FIG. 1, a perspective view is provided of a clasp 25 in its initial state prior to being formed as part of a dental appliance. The major components of the clasp 25 include two substantially parallel wires 30, 40 and a bridge segment 50 extending between these wires adjacent to their exposed ends. This results in a generally H-shaped configuration. The exposed ends of both wires 30, 40 are enlarged to form two ball clasps 35 and 45.

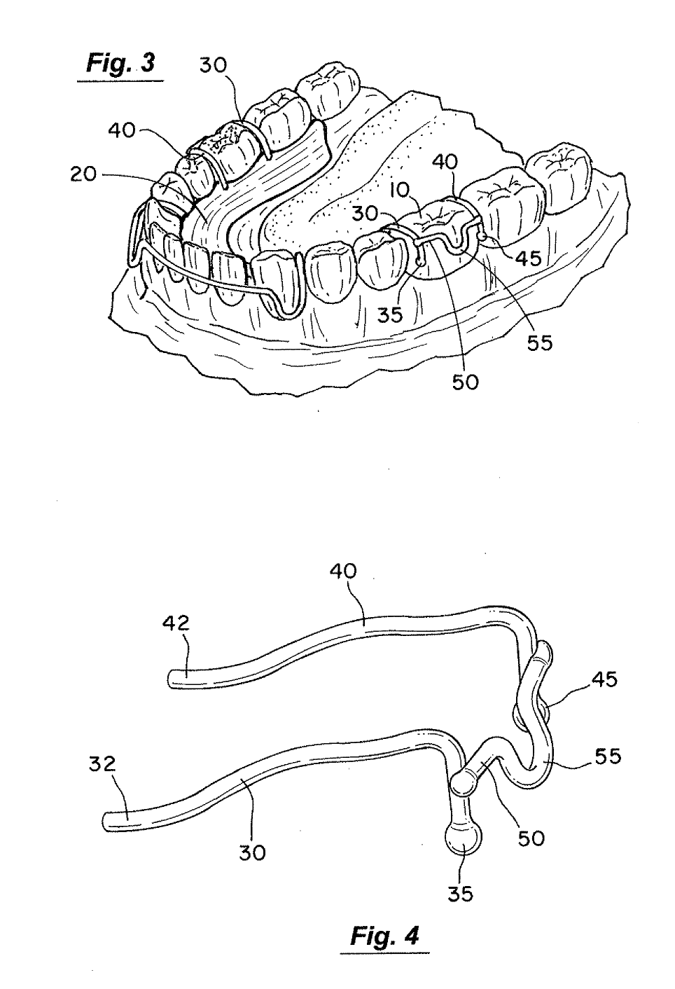

FIG. 2 is a perspective view of a removable dental appliance incorporating a number of these clasps 25. As previously mentioned, the body of a removable dental appliance typically includes an acrylic portion 20 that serves to anchor metallic components of the appliance. For example, the appliance shown in FIG. 2 also includes a conventional labial bow. With the present clasp 25, the stems 32 and 42 of both wires 30, 40 are embedded in the acrylic portion 20 of the appliance. The remaining, exposed portions of the wires 30, 40 can be formed by a technician to extend outward from the acrylic 20 and over the interproximal regions between a patient's teeth 10. FIG. 4 is a perspective view of a clasp 25 after adapting and forming. FIG. 3 is a perspective view of the dental appliance in place on a patient's lower teeth. The ball clasps 35, 45 extend gingivally on the buccal aspect of the tooth as shown in FIG. 2. The bridge segment 50 runs in a generally mesial-distal direction between the ball clasps 35, 45 on the buccal aspect of the tooth 10. The bridge segment is also generally perpendicular to both wires 30, 40

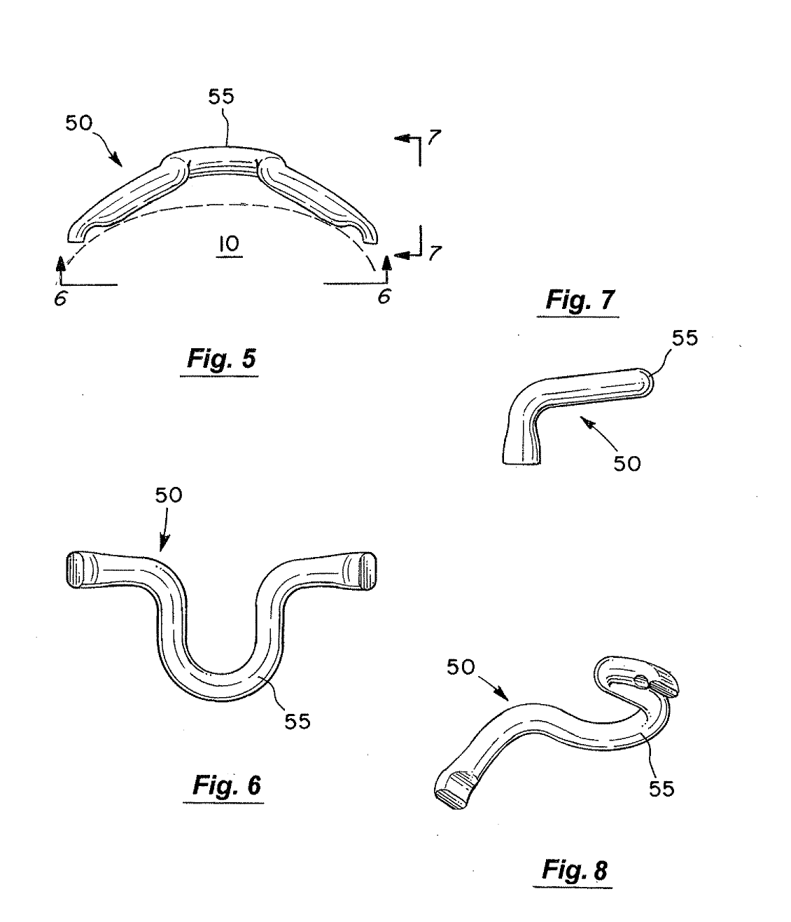

FIGS. 5-7 show a series of views of a bridge segment 50 of a clasp 25. The width of the overall clasp 25 is largely dependent on the width of the bridge segment 50. Thus, the clasp can be offered in statistically pre-determined widths and contours to meet the requirements of a variety of teeth. Various configurations of the bridge segment 50 can be readily provided by the manufacturer and further adjusted if necessary in the dental office by the dental professional) to maintain a close contour to the buccal morphology on a tooth-by-tooth basis. For example, even though a lower first molar may have a large mesial-to-distal dimension, it may not have a particularly large buccal contour radius. In other words, the buccal surface of statistically-normal lower first molar teeth is naturally more outwardly rounded, exhibiting a shorter curvature radius, whereas in contrast, the upper first molar presents a somewhat flatter buccal aspect. An important aspect of the present invention is that the bridge portion 50 of the clasp 25 can be optimally configured with center-to-center dimensions that are independent from the radius of the curvature of the bridge segment. By establishing configurations of the various bridge segments, where the center-to-center values and the radius values are independent and non-proportional, each bridge configuration can maintain the closest contour to a specific buccal morphology on a tooth-by-tooth basis. These accommodations provide the advantages of a more highly bio-engineered fit than conventional clasps, and thereby enhance patient comfort due to a much closer-to-the-tooth profile while also providing for a more positive retention of removable dental appliances. This array of potential center-to-center values and radius values can be reduced to a manageable number of predefined configurations for typical tooth parameters. For example, the clasp could be manufactured in one configuration for a typical upper molar, one for a typical lower molar, one for a typical bicuspid, etc.

For example in FIG. 5, a bridge portion 50 of a clasp is shown that is sized and shaped to accommodate a bicuspid tooth 10. For example, a 0.300 in. diameter curvature of the part allows the bridge section 50 to wrap around the buccal contour of generally-round bicuspid teeth 10. FIGS. 5, 6 and 8 show the configuration of the end portions of the bridge segment 50 where the ball clasps 35, 45 are attached. The 0.027 in. diameter receiving feature (e.g., spanning about 130°) matches the typical OD of the stem portion of a conventional ball clasp. Joining of the two ball clasps 35, 45 to the bridge segment 50 at these points can be accomplished by standard laboratory means including laser tack welding, laser welding, resistance tack-welding, resistance welding and brazing. Laser welding can be further reinforced by adding additional filler metal during the welding step. The filler metal most commonly used is a cobalt alloy.

A clasp optimized for a lower first molar (which is the tooth with the largest mesial-distal extent) could have a center-to-center distance for the location of the ball clasp stems of 0.3976 in. An upper first molar is slightly smaller and may require a mesial-distal value of about 0.3583 in. The center-to-center distance for the bridge segment optimized for the bicuspid teeth is still less at about 0.236 in.

Optionally, the bridge segment 50 can include a U-shaped expansion loop 55. This allows a degree of lateral expansion of the bridge segment to adjust the lateral spacing between the ball clasps 35, 45. In addition, the loop 55 provides a convenient, smaller handle for disengaging the clasp 25 from a tooth 10 that is not as irritating to the adjacent soft tissues.

As shown in the side view of the bridge segment 50 in FIG. 7, the loop portion 55 of the bridge can be canted outward at an angle of about 10° with respect to the tooth surface. This outward orientation provides a handle that allows the patient to lift the appliance from its seated position using a fingernail. This feature is similar in some respects to a segment of an Adams clasp. However, the loop portion 55 of the bridge segment 50 is far less prominent than the straight bridge structure of the Adams clasp. The much more compact, less prominent, contoured profile of the loop 55 of this clasp 25 creates no corners as does the Adams configuration. The present invention therefore provides enhanced patient comfort along with a more compact and functional handle for removal.

Yet another advance in clasp design forwarded by the present invention involves the force vectors with which the clasp 25 grasps an individual tooth 10 that it is adapted to engage. To best disclose this aspect of the present invention, the reader is asked to reconsider earlier discussions involving the point that conventional ball clasps function by energetically engaging the embrasure between two teeth. As described above, conventional ball clasps serve to retain the appliance in which they are embedded by positively flexing into the embrasure and in a sense, the ball portion jams into the interface between two teeth. As such, the inward force of the ball portion can, over time, cause the two contacted teeth to undesirably reposition in response to the inward jamming and wedging effect of the ball. The stored energy in the stem portion that inwardly biases the ball can itself cause an unwanted orthodontic problem.

In contrast, the present clasp can be designed to place no wedging forces in the interproximal embrasure between adjacent teeth, because both ball clasps 35, 45 contact only the same single tooth. The center-to-center dimension described earlier regarding the locations of the ball clasps 35, 45 can be less than the over-all mesial-distal width of its corresponding tooth 10. For example, the mesial-distal width of the overall clasp 25 for a lower first molar is less than the full mesial-distal width of the lower first molar itself. In particular, a statistically-normal lower first molar will exhibit a mesial-distal width of about 0.449 in., whereas the center-to-center width of the lower first molar bridge segment is less, being set at 0.397 in., meaning that the bridge segment is 0.051 in. narrower than the tooth. In other words, the bridge segments 50 for each of a series of clasps according to the present invention can be designed to be correspondingly narrower than the corresponding tooth that each clasp is intended to grasp.

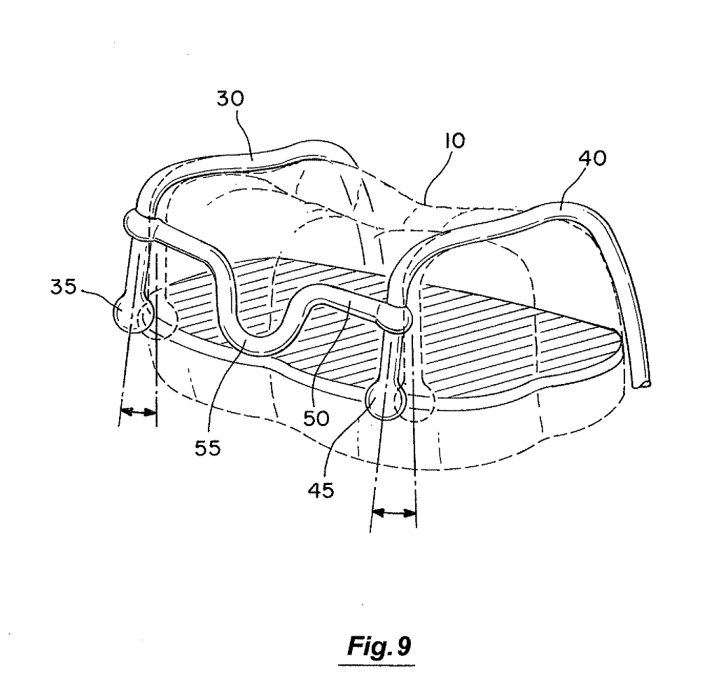

FIG. 9 illustrates the manner in which the present clasp 25 flexes as a removable appliance is moved to a fully-seated position over a molar. The shaded slice represents the occlusal-gingival level where the molar is contacted by the balls clasps 35, 45. The ball clasps 35, 45 are positioned in a manner on the buccal aspect of the tooth 10 representative of the positions in which they would be positioned by the bridge segment 50. The novel manner in which the ball clasps 35, 45 flex should be noted, and in particular the unique axis or plane of that flexing. As the removable appliance is seated in the patient's mouth, the ball clasps 35, 45 flex between the positions shown in solid and dashed lines in FIG. 9. A novel aspect of the present inventive device is that this flexing occurs planar to the shaded slice in FIG. 9.

This can also be visualized in another manner. There is a central axis to the crown of any tooth, even a molar. This axis can be likened to the shaft of an umbrella. Each rib of an umbrella expands radially outward and upward from the shaft as the umbrella opens. Similarly, the ball clasps 35, 45 in the present invention flex toward and away from the central axis of the crown as the appliance is seated. In other words, the present invention allows non-parallel flexing of the ball clasps 35, 45.

Together, all of the features described combine in the form of the present invention to provide a clasp that produces a much more positive and precise snap into position than any conventional clasp can produce. Accurate and repeatable positioning of a removable appliance in the mouth facilitates targeted tooth movements and attainment of treatment goals identified by the practitioner. Several features of the present clasp represent improvements in the area of patient comfort and in ease of removing the appliance. Importantly, the present invention itself does not cause unwanted reciprocal tooth movement and therefore it eliminates the need for reciprocal tooth stabilizing features to be incorporated into the acrylic portion of the appliance.

The embodiment of the clasp shown in the accompanying drawings employs two parallel wires 30 and 40 to provide both the stem segments 32, 42 that are embedded in the acrylic portion 20 of a dental appliance, and the flexible members for the ball clasps 35, 45. It should be expressly understood that other configurations could be readily substituted. The wires can have any desired cross-sectional shape, including round or rectangular. Any number of wires can be used to form the lingual portions of the clasp. These wires could also be replaced with other types of flexible elongated members. The stem segments 32, 42 could be formed by one or more flat members suitable for being embedded in the acrylic portion 20 of a dental appliance. These stem segments 32, 42 could also be serpentined or corrugated to increase the surface area in contact with the acrylic.

The embodiment of the clasp shown in the drawings also employs the exposed ends of the wires 30, 40 to serve as flexible members for the ball clasps 35 and 45. This approach has an elegant simplicity. However, it should be understood that other configurations and/or other types of flexible members could be readily substituted. In general terms, the phrase “ball clasp” should be interpreted to include any type of flexible member (e.g., a wire) with an enlarged head or ball at its exposed end.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A clasp for a removable dental appliance having an acrylic portion, said clasp comprising:
a stem for being embedded into, and extending from the acrylic portion of a dental appliance;
a first ball clasp extending from the stem and having an elongated flexible member with an enlarged end;
a second ball clasp extending from the stem laterally spaced apart from the first ball clasp and having an elongated flexible member with an enlarged end; and
a bridge segment extending between the flexible members of the first and second ball clasps.

2. The clasp of claim 1 wherein the stem comprises two parallel wires.

3. The clasp of claim 1 wherein the bridge segment further comprises an expansion loop.

4. The clasp of claim 1 wherein the clasp is substantially H-shaped.

5. The clasp of claim 1 wherein the first ball clasp is spaced apart from the second ball clasp by a distance selected for allowing the flexible members of the ball clasps to extend over the interproximal regions between a patient's teeth.

6. The clasp of claim 5 wherein the bridge segment extends between the flexible members of the ball clasps around the contours of a patient's teeth.

7. A clasp for a removable dental appliance having an acrylic portion, said clasp comprising:
a first flexible elongated member having:
(a) a stem for being embedded into the acrylic portion of a dental appliance; and
(b) an exposed portion for extending over the interproximal region between a patient's teeth;
a second flexible elongated member having:
(a) a stem for being embedded into the acrylic portion of a dental appliance; and
(b) an exposed portion for extending over the interproximal region between a patient's teeth;
a bridge segment extending between the exposed portions of the first and second elongated members;
a first ball clasp extending from the bridge segment for contacting a patients tooth; and
a second ball clasp extending from the bridge segment for contacting a patient's tooth.

8. The clasp of claim 7 wherein the exposed portion of the first elongated member forms the first ball clasp.

9. The clasp of claim 8 wherein the first elongated member and first ball clasp comprise a wire with an enlarged end.

10. The clasp of claim 7 wherein the exposed portion of the second elongated member forms the second ball clasp.

11. The clasp of claim 10 wherein the second elongated member and second ball clasp comprise a wire with an enlarged end.

12. The clasp of claim 7 wherein the clasp is substantially H-shaped.

13. The clasp of claim 7 wherein the bridge segment further comprises an expansion loop.

14. A clasp for a removable dental appliance having an acrylic portion, said clasp comprising:
a first wire having a stem for embedding into the acrylic portion of a dental appliance and an exposed portion forming a first ball clasp;
a second wire having a stem for embedding into the acrylic portion of a dental appliance and an exposed portion forming a second ball clasp; and
a bridge segment extending between the first and second wires adjacent to the first and second ball clasps.

15. The clasp of claim 14 wherein the clasp is substantially H-shaped.

16. The clasp of claim 14 wherein the exposed portions of the first and second wires extend over the interproximal regions of a patient's teeth.
